(19) United States
(12) Patent Application Publication
(10) Pub. No.: US 2025/0340414 A1
(43) Pub. Date: Nov. 6, 2025

(54) METHOD AND CONTROL DEVICE FOR CONTROLLING AN INDUSTRIAL TRUCK

(71) Applicant: ZF Friedrichshafen AG, Friedrichshafen (DE)

(72) Inventors: Gabriela Jager, Friedrichshafen (DE); Michael Walter, Bobingen (DE); Markus Birk, Mittelbiberach (DE); Stefan Traub, Friedrichshafen (DE)

(73) Assignee: ZF Friedrichshafen AG, Friedrichshafen (DE)

(21) Appl. No.: 18/871,085

(22) PCT Filed: May 22, 2023
(86) PCT No.: PCT/EP2023/063544

§ 371 Date: Dec. 2, 2024

(30) Foreign Application Priority Data
Jun. 2, 2022 (DE) 10 2022 205 674.4

(51) Int. Cl. B66F 9/06; B66F 9/075; B66F 9/24; G06V 20/58

(52) U.S. Cl. CPC B66F 9/063; B66F 9/0755; B66F 9/24; G06V 20/58

(57) ABSTRACT

A method for controlling an industrial truck in a warehouse includes reading-in (S1) a point cloud of the warehouse is the surroundings of the industrial truck, wherein the point cloud read in contains point information of at least one object present in the surroundings, converting (S3) the point information into a frequency distribution of the point information, determining (S4) a statistical distribution parameter of the point information in the frequency distribution, classification (S5) of the object as a person or as a warehouse technology object on the basis of the statistical distribution parameter, and emitting (S6) a control signal to control the industrial truck in the warehouse on the basis of the result of the classification in the classification step (S5). The invention also describes a control unit for carrying out the method and an industrial truck with a control unit of that type.

### RELATED APPLICATIONS

This application claims the benefit under 35 U.S.C. § 371 as a U.S. National Phase Application of application No. PCT/EP2023/063544, filed on 22 May 2023, which claims the benefit of German Patent Application No. 10 2022 205 674.4 filed on 2 Jun. 2022, the contents of which are hereby incorporated herein by reference in their entireties.

### TECHNICAL FIELD

The present invention relates to a method and a control unit for controlling an industrial truck in a warehouse. The present invention also relates to an industrial truck with a control unit of that type.

### BACKGROUND

From the prior art it is known to control a vehicle on the basis of detecting its surroundings. For example, from DE 10 2018 117 428 Al it is known to detect objects in the surroundings of a vehicle and to classify them on the basis of their contours. Furthermore, from WO 2020/049154 A1 it is known to extract sensor-independent features in order to carry out an object classification based on a neuron network.

### SUMMARY

One aspect of the present invention relates to a method for controlling an industrial truck in a warehouse. The industrial truck is an industrial means for transporting goods. The industrial truck can be a conveyor vehicle or a floor conveyor. For example, the industrial truck is a fork-lift truck. The warehouse can provide storage for a production operation or for a logistics system. The warehouse can contain goods that are to be transported by the industrial truck.

The method comprises, as one step, reading-in a point cloud of the warehouse in the surroundings of the industrial truck. As a further step, the method can comprise detecting the point cloud with an environment detection sensor system. To detect the point cloud the environment detection sensor system can be arranged on the industrial truck. As a further step the method can comprise emitting a control signal for detecting the point cloud with the environment detection sensor system.

The environment detection sensor system can comprise a distance-measuring sensor. Alternatively, or in addition, the environment detection sensor system can comprise an image-registering sensor. The distance-measuring sensor can be in the form of a scanning sensor. For example, the distance-measuring sensor can be a laser scanner, a radar measuring device, or an ultrasonic measuring device. The laser scanner, the radar measuring device, or the ultrasonic measuring device can be in the form of a two-dimensionally or a three-dimensionally scanning sensor.

If the environment detection sensor system comprises the distance-measuring sensor, the warehouse in the vicinity of the industrial truck can be registered or scanned point by point. With the distance-measuring sensor the point cloud of the warehouse in the surroundings of the industrial truck can be registered. The point cloud can be a two-dimensional or a three-dimensional point cloud. The image-registering sensor can be in the form of a camera system. The camera system can comprise an RGB camera. The camera system can comprise a stereo camera system. If the environment detection sensor system comprises an image-registering sensor alternatively or in addition to a distance-measuring sensor, an image of the warehouse in the vicinity of the industrial truck can be registered or recorded. With the image-registering sensor a point cloud with image points of the warehouse can be recorded.

The read-in point cloud contains point information of at least one object located in the surroundings. The point information can comprise the measurement points detected by the distance-measuring sensor. Alternatively, or in addition, the point information can comprise the image points recorded by the image-registering sensor. The point information can include metadata about the measurement points. Alternatively, or in addition, the point information can include metadata about the image points. The point information can include at least one point coordinate of the measurement point. Alternatively, or in addition, the point information can include at least one color information in a visible or invisible spectrum range of the image point.

As a further step, the method comprises the conversion of the point information into a frequency distribution of the point information. The conversion of the point information can entail converting the point information from a sensor-related coordinate system to a coordinate system of the frequency distribution. The frequency distribution can be a one-dimensional or a multi-dimensional frequency distribution. The frequency distribution can be a statistical function that indicates how frequently the point information points occur. Thus, some part of the point cloud read in can be converted into the frequency distribution. Accordingly, in the step of converting the point information, a multi-dimensional point cloud can be transformed into a one-dimensional frequency distribution. For this, the point information can form a one-dimensional part-quantity of the point cloud. The point information can form a one-dimensional part-quantity of the point cloud derived therefrom. Thus, subsequent steps of the method can be carried out in a particularly efficient manner on the basis of the transformed frequency distribution.

As a further step, the method comprises determining a statistical distribution parameter of the point information in the frequency distribution. The statistical distribution parameter can be a scatter of the point information in the frequency distribution. Thus, for example, the statistical distribution parameter can be a standard deviation or variance of the point information in the frequency distribution. Accordingly, by virtue of the statistical distribution parameter, an inhomogeneity of the point information can be determined.

As a further step, the method comprises a classification of the object as a person or as a warehouse technology object on the basis of the statistical parameter. The object can be an obstacle for the industrial truck or a work object for the industrial truck. By virtue of the method the industrial truck can be controlled in such manner that a collision with the obstacle is avoided. By virtue of the method the industrial truck can also be controlled in such manner that its approach toward the work object is improved. According to an embodiment the classes used for classifying objects cover persons and warehouse technology objects.

In the classification step, the object can be classified, as a function of a threshold value for the statistical distribution parameter, into persons or warehouse technology objects. If the threshold value is exceeded, the object can be classified as a person. A value below the threshold classifies the object as a warehouse technology object. Classification of the object with reference to the statistical distribution parameter is based on the recognition that point information relating to persons can be inhomogeneous compared with point information relating to warehouse technology objects. From the inhomogeneity a corresponding statistical distribution parameter, for example a wider scattering of the point information, can result in the frequency distribution.

As a further step, the method comprises the emission of a control signal for controlling the industrial truck in the warehouse on the basis of a classification resulting from the classification step. According to an embodiment, the resulting classifications consist of classification as a person and classification as a warehouse technology object. The control signal can be emitted as a function of whether the object has been classified as a person or as a warehouse technology object.

Thus, by virtue of the invention, a classification as a person or as a warehouse technology object can be carried out on the basis of a statistical distribution of point information, in order to control the industrial truck automatically as a function of the classification as a person or as a warehouse technology object. The statistical distribution parameter can differ significantly depending on whether the point information relates to a person or a warehouse technology object. Thus, the steps of classification and of controlling the industrial truck can be carried out reliably.

In an embodiment of the method, the point information read in can relate to at least two objects present in the surroundings. As a further step, the method can comprise the segmenting of the point cloud read in, into at least one segment. From the point information of the point cloud read in, the segment can contain the point information associated with one object of the at least two objects. The segmenting can be carried out on the basis of the point information. Thus, a segment can contain point information that relates only to one object. In the step of conversion, the associated point information can be converted to the frequency distribution. Accordingly, the frequency distribution and the statistical distribution parameter determined can relate to a segmented object, which can be a person or a warehouse technology object.

The warehouse technology object can consist, for example, of a rack or a pallet, or can be an object of that kind. Furthermore, the warehouse technology object can be an object of the infrastructure of the warehouse. A person can be a pedestrian in the warehouse. Thus, the steps of the method can be carried out for numerous objects in the surroundings. Accordingly, the method can also be carried out reliably when there are both persons and warehouse technology objects in the surroundings of the industrial truck.

According to a further embodiment of the method, in the step of determining the statistical distribution parameter, the statistical distribution parameter can be determined on the basis of a scatter parameter in the frequency distribution. The scatter parameter can be the standard deviation or the variance of the point information in the frequency distribution. Thus, the object classification step can be carried out as a function of the scatter parameter. If the scatter parameter exceeds a predetermined threshold value, then the object can be classified as a person. If the scatter parameter is lower than the predetermined threshold value, then the object can be classified as a warehouse technology object. Thus, the classification can be carried out efficiently on the basis of the scatter of the point information.

In a further embodiment of the method, in the step of conversion the point information can be converted into a histogram of the point information. The point information can be converted to the histogram as an image of the point information. In the step of determining the statistical distribution parameter. the distribution parameter can be determined in the histogram or in a portion of the histogram. The distribution parameter can be determined on the basis of a control parameter in the histogram. The statistical distribution parameter can be determined in the histogram functionally or in an image-based manner. Thus, in a particularly efficient way the distribution parameter can be determined using image-processing methods for the depiction of the point information in the histogram. Accordingly, the method can be carried out advantageously even without an AI approach.

According to a further embodiment, the point information from the point cloud read in can contain spatial point coordinates of the at least one object present in the surroundings. The spatial point coordinates can be at least one-dimensional point coordinates of the at least one object present in the surroundings. In the conversion step the spatial point coordinates can be converted into the frequency distribution. The statistical distribution parameter or the control parameter can thereby define a scatter of the spatial point coordinates of the object. Thus, the classification described can be carried out as a function of a spatial extension of the object in at least one dimension.

According to a further embodiment of the method, the point information from the point cloud read in can comprise signal intensities of the measurement signals reflected at the objects present in the surroundings for detecting the point cloud. In the step of conversion, the signal intensities can be converted into the frequency distribution. Thus, the statistical distribution parameter or the scatter parameter determined can define a scatter of the signal intensities of the measurement signals reflected at the objects. Accordingly, the classification can be carried out as a function of material properties or a geometry of the object that can influence the signal intensities.

In a further embodiment of the method, the point information of the point cloud read in can comprise spatial speed coordinates of the at least one object present in the surroundings. If the environment detection sensor system includes a radar sensor, the spatial speed coordinates can be determined from measurement data from the radar unit. In the step of conversion, the spatial speed coordinates can be converted into the frequency distribution. The statistical distribution parameter or the scatter parameter determined can define a scatter of the spatial speed coordinates. Thus, the classification can be carried out as a function of whether parts of the object are moving relative to one another or whether the object is a static object.

According to a further embodiment of the method, in the step of emitting the control signal, a control signal for interrupting a working task being carried out by the industrial truck on a working device of the industrial truck can be emitted. The working device can be a working device for driving the industrial truck. The working device can also be a transporting device or a lifting device of the industrial truck for transporting or lifting goods. The control signal for interrupting the working task can be emitted if, in the classification from the classification step, the object is classified as a person. Thus, a movement of the industrial truck while carrying out the working task can be stopped on the basis of the control signal in order to ensure the working safety of the person.

In a further embodiment of the method, in the step of emitting the control signal a control signal for controlling or limiting a drive dynamic of the industrial truck can be emitted. The control signal can be emitted in order to limit a longitudinal dynamic of the industrial truck. In that way a speed or acceleration of the industrial truck can be limited. The control signal can also be emitted for braking the industrial truck. The control signal can be emitted in order to limit a transverse dynamic of the industrial truck. Thus, a steering angle of the industrial truck can be limited. The control signal for limiting the drive dynamic can be emitted if, in the classification from the classification step, the object is classified as a warehouse technology object. Alternatively, the control signal can also be emitted if, in the classification from the classification step, the object is classified as a person.

According to a further embodiment of the method, the step of classification can be carried out on the basis of a machine learning model. The machine learning model can be structured in accordance with an AI approach or as a neuron network. In this embodiment, at least one of the frequency distribution and the statistical distribution parameter can be read into the machine learning model. In that way, the frequency distribution or the statistical distribution parameter can advantageously first form an input magnitude for the machine learning model.

In a further embodiment of the method, the step of classifying the object can be carried out on the basis of the machine learning model, wherein the histogram is read into the machine learning model. Thus, in a particularly efficient manner a histogram-based classification of the object can be carried out on the basis of the histogram. The image-based evaluation of the histogram is particularly advantageous in that case.

A second aspect of the present invention relates to a control unit for controlling an industrial truck in a warehouse. The control unit comprises an interface for reading-in a point cloud of the warehouse in the surroundings of the industrial truck. The point cloud read in contains point information of at least one object present in the surroundings.

The control unit is designed to convert the point information into a frequency distribution of the point information. Furthermore, the control unit is designed to determine a statistical distribution parameter of the point information in the frequency distribution.

Moreover, the control unit is designed to classify the object as a person or as a warehouse technology object on the basis of the statistical distribution parameter. The control unit also has an interface for emitting a control signal in order to control the industrial truck in the warehouse on the basis of the resulting classification.

The control unit can be designed to carry out the method according to the preceding aspect. The control unit can be arranged on the industrial truck. Features and embodiments of the method according to the preceding aspect can be corresponding features and embodiments of the control unit, so that the control unit can be designed to carry out each step of the method described. The control unit can comprise appropriate units for carrying out the steps of the method.

A further aspect of the present invention relates to an industrial truck. The industrial truck can be designed as described in relation to the preceding aspects. The industrial truck comprises a control unit for controlling the industrial truck in accordance with the preceding aspect.

### BRIEF DESCRIPTION OF THE FIGURES

FIG. 1: An industrial truck and a control unit for controlling the industrial truck, in accordance with any of the embodiments of the invention.

FIG. 2: A schematic representation of the industrial truck in a warehouse, in order to explain the invention.

FIG. 3: A flow chart with process steps for carrying out a method for controlling the industrial truck, in accordance with an embodiment of the invention.

### DETAILED DESCRIPTION OF EMBODIMENTS

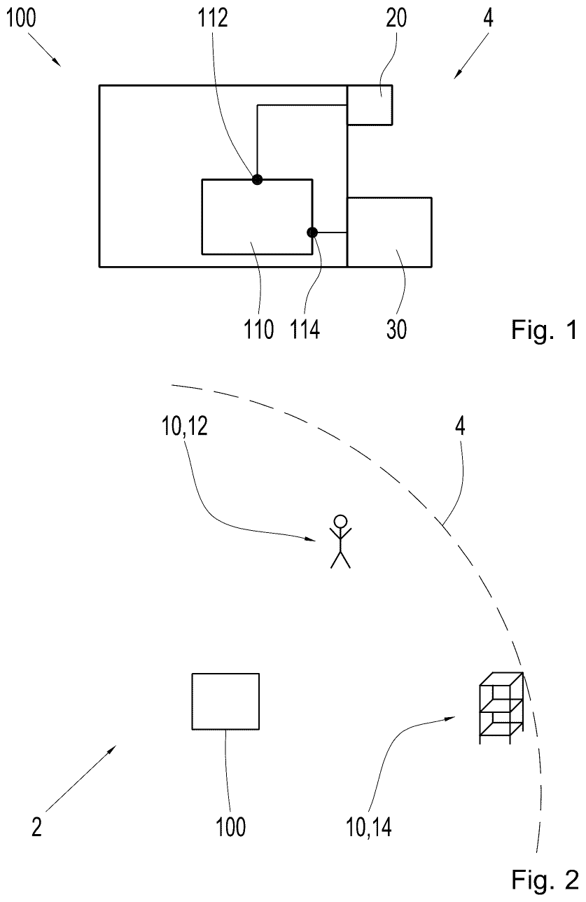

FIG. 1 shows an industrial truck 100 which comprises a working device 30 for carrying out a working task by means of the industrial truck 100. On the industrial truck there is arranged an environment detection sensor system 20 by which a point cloud in the surroundings 4 of the industrial truck 100 is detected. The point cloud contains pre-processed measurement data from the environment detection sensor system 20. The point cloud contains points relating to an object 10 which is present in the surroundings 4 of the industrial truck 100 and is shown in FIG. 2.

The industrial truck 100 comprises a control unit 110 for controlling the working device 30. The point cloud detected by the environment detection sensor system 20 is read in via an interface 112 of the control unit 110 and processed in order to control the working device 30 on the basis of processed point information. According to an embodiment the point cloud contains the point information read in by the control unit 110. In a further embodiment the point information of the read-in point cloud is derived by the control unit 110 from the point cloud. On the basis of the point information, the control unit 110 emits a control signal via an interface 114, for controlling the working device 30.

FIG. 2 shows the industrial truck 100 in a warehouse 2. In the warehouse 2 there are objects 10 in the surroundings 4 of the industrial truck 100. The point cloud detected in the surroundings 4 contains measurement data or points relating to the objects 10. One of the objects 10 is a person 12 in the warehouse and another object 10 in the warehouse 2 is a warehouse technology object 14, in the case of this embodiment a rack.

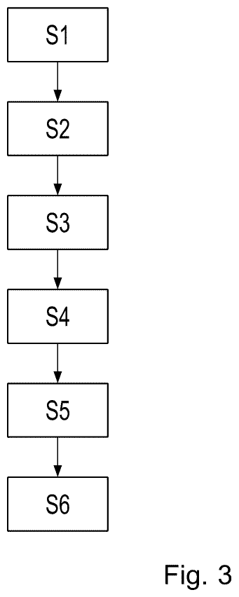

FIG. 3 shows process steps S1 to S6 for controlling the industrial truck 100, which steps are carried out by the control unit 110.

In a first step S1 the control unit 110 reads in the point cloud via the interface 112. The point cloud read in contains point information about the objects 10 present in the surroundings 4. According to an embodiment, the point information comprises point coordinates. In a further embodiment the point information contains signal intensities of the measurement signals of the environment detection sensor system 20 reflected at the objects 10.

In a second step S2 the control unit 110 carries out a segmentation of the point cloud or point information. The point cloud read in is segmented into at least two segments. A first segment contains point information associated with one of the objects 10. A second segment contains point information associated with the other of the objects 10. By virtue of the segmentation step, point information relating to different objects can thus be separated. The subsequent steps of the method are then carried out for the respectively associated point information sets.

In a third step S3 the control unit 110 converts the point information sets into a frequency distribution. The segmented point information is converted into a histogram which indicates the frequency of the segmented point information sets. In corresponding embodiments, the histogram shows the frequencies of the point coordinates and the signal intensities.

In a fourth step S4 the control unit 110 determines a distribution parameter in the frequency distribution. The distribution parameter is a scatter parameter of the frequencies of the histogram. The histogram forms an input magnitude for a machine learning model for classifying the object 10 as a person 12 or a warehouse technology object 14 on the basis of the scatter of the segmented point information sets. According to an embodiment the scatter parameter constitutes a classification magnitude in the machine learning model.

In a fifth step S5 the control unit 110 classifies the objects as a person 12 or as a warehouse technology object 14. A classification as a person 12 or a warehouse technology object 14 is an output parameter of the machine learning model, which according to the embodiment described is based on the scatter parameter. The machine learning model is based on the assumption that the point coordinates or signal intensities associated with a person 12 will be more markedly scattered than the point coordinates or signal intensities associated with a warehouse technology object 14. The greater scatter of the signal intensities in the case of a warehouse technology object 14 is based on the assumption that the warehouse technology object 14 is a flatter or less curved object 10, at least relative to a coordinate axis and compared with a person 12. The greater scatter of the signal intensities for a person 12 is based on the assumption that compared with the warehouse technology object 14, a person 12 has an object surface that can be detected by the environment detection sensor system 20, which surface has more materials and curvatures that result in more inhomogeneous and therefore more markedly scattered signal intensities of the measurement signals reflected by the object surface.

In a sixth step S6 the control unit 110 emits the control signal via the interface 114 to the working device 30. If the result of the preceding classification step S5 is that a person 12 is in the surroundings 4 of the industrial truck 100, the control signal emitted to the working device 30 is such that the performance of the working task is interrupted. If the result of the preceding classification step S5 is that a warehouse technology object 14 is in the surroundings 4 of the industrial truck 100, then a control signal is emitted to the working device 30 by which the drive dynamic of the industrial truck 100 is affected. A hazard posed by the industrial truck 100 for the working safety of the person 12 is thereby reduced and work carried out by the industrial truck 100 in the warehouse 2 is consequently improved.

### INDEXES

2 Warehouse
4 Surroundings
10 Object
12 Person
14 Warehouse technology object
20 Environment detection sensor system
30 Working device
100 Industrial truck
110 Control unit
S1 Reading in the point cloud
S2 Segmenting the point cloud
S3 Converting the point information
S4 Determining the distribution parameter
S5 Classifying the object
S6 Emitting the control signal

1. A method for controlling an industrial truck (100) in a warehouse (2), comprising:
reading in (S1) a point cloud of the warehouse (2) in the surroundings (4) of the industrial truck (100), wherein the point cloud comprises point information of at least one object (10) present in the surroundings (4);
converting (S3) the point information into a frequency distribution of the point information;
determining (S4) a statistical distribution parameter of the point information in the frequency distribution
classifying (S5) the object (10) as a person (12) or a warehouse technology object (14) on the basis of the statistical distribution parameter; and
emitting (S6) a control signal for controlling the industrial truck (100) in the warehouse (2) on the basis of a classification resulting from the classification step (S5).

2. The method according to claim 1, wherein the point cloud read in comprises information of at least two objects (10) present in the surroundings (4), and wherein the method comprises as a further step a segmenting (S2) of the point cloud read in, into at least one segment which, of the point information from the point cloud read in, comprises point information associated with one object (10) of the at least two objects (10), and wherein in the conversion step (S3) the associated point information is converted into the frequency distribution.

3. The method according to claim 1, wherein determining the statistical distribution parameter is performed on the basis of a scatter parameter in the frequency distribution.

4. The method according to claim 1, wherein converting the point information includes converting the point information into a histogram, wherein determining the statistical distribution parameter is performed in the histogram, and wherein the distribution parameter is determined in the histogram on the basis of a scatter parameter.

5. The method according to claim 1, wherein the point information of the point cloud comprises spatial point co-ordinates of the at least one object (10) present in the surroundings (4), and wherein converting the spatial point coordinates includes converting spatial point coordinates into the frequency distribution.

6. The method according to claim 1, wherein the point information of the point cloud read in comprises signal intensities of measurement signals reflected at the at least one object (10) present in the surroundings (4) for detecting the point cloud, and wherein, in the step (S3) of converting includes converting signal intensities into the frequency distribution.

7. The method according to claim 1, wherein the point information of the point cloud read in contains spatial speed co-ordinates of the at least one object (10) present in the surroundings (4), and wherein, in the step (S3) of converting includes transferring spatial speed coordinates into the frequency distribution.

8. The method according to claim 1, wherein the object is classified as a person and wherein emitting the control signal includes sending a control signal for interrupting a working task being carried out by the industrial truck (100) to a working device (30) of the industrial truck (100).

9. The method according to , claim 1, wherein the object is classified as a warehouse technology object (14) and emitting the control signal includes emitting a control signal for limiting a drive dynamics of the industrial truck (100).

10. The method according to claim 1, wherein classifying the object (10) is carried out on the basis of a machine learning model, wherein at least one of the frequency distribution and the statistical distribution parameter is read into the machine learning model.

11. The method according to claim 4, wherein classifying the object (10) is carried out on the basis of the machine learning model, wherein the histogram is read into the machine learning model.

12. A control unit (110) for controlling an industrial truck (100) in a warehouse (2), comprising:
an interface (112) configured for reading-in a point cloud of the warehouse (2) in the surroundings (4) of the industrial truck (100), wherein the point cloud read in contains point information of at least one object (10) present in the surroundings (4); and
an interface (114) for emitting a control signal for controlling the industrial truck (100) in the warehouse (2) on the basis of the resulting classification;
wherein the control unit (110) is designed configured to:
convert the point information into a frequency distribution of the point information,
determine a statistical distribution parameter of the point information in the frequency distribution,
classify the object (10) in a category as a person (12) or as a warehouse technology object (14) on the basis of the statistical distribution parameter.

13. An industrial truck (100) with the control unit (110) for controlling the industrial truck (100) in accordance with claim 12.
